(19) United States
(12) Patent Application Publication
(10) Pub. No.: US 2020/0016675 A1
(43) Pub. Date: Jan. 16, 2020

(54) TOUCH RETRACT WELDING TORCH

(71) Applicant: AMADA MIYACHI UK LIMITED, Mildenhall (GB)

(72) Inventors: Mark AHERNE, Manningtree (GB); Mariusz SZPIECH, Thetford (GB)

(73) Assignee: AMADA MIYACHI UK LIMITED, Mildenhall (GB)

(21) Appl. No.: 16/498,241

(22) PCT Filed: Mar. 29, 2018
(86) PCT No.: PCT/IB2018/052202

§ 371 Date: Sep. 26, 2019

(30) Foreign Application Priority Data
Mar. 31, 2017 (GB) 1705253.1

(51) Int. Cl. B23K 9/067; B23K 9/12; B23K 9/133; B23K 9/167

(52) U.S. Cl. CPC B23K 9/0671; B23K 9/125; B23K 9/167; B23K 9/1336; B23K 9/126

(57) ABSTRACT

This invention relates to an apparatus for use in welding, in particular in Tungsten Inert Gas (TIG) welding. The invention provides a touch retract welding torch (10) comprising: an electrode (27); a nozzle (28) surrounding the electrode (27); a mechanical retraction mechanism (21) comprising a gripper (13) for clamping the electrode and arranged in operation to engage the gripper and retract the electrode (27) away from a weld site by a predetermined distance; activating means (24) arranged in operation to trigger said retraction mechanism while providing the basis by which an arc maybe drawn from an initial contact point and maintained consistently over a significant number of operational cycles.

### BACKGROUND

### a. Field of the Invention

This invention relates to an apparatus and method for use in welding, in particular in Tungsten Inert Gas (TIG) welding.

TIG welding, also known as Gas Tungsten Arc Welding (GTAW), is an arc welding process that uses a non-consumable tungsten electrode to produce a weld arc. Non-consumable meaning the electrode does not form part of the bonding material. Even with a non-consumed electrode process a very small amount of the electrode is lost each time an arc is struck. Eventually the electrode will need to be replaced. The weld area is often protected from atmospheric contamination by an inert shielding gas (such as argon or helium). A power supply produces electrical energy, which is conducted across an arc to create a weld.

### b. Related Art

In known process controlled TIG welding systems the electrode is at a set distance from the workpiece, a very short period, high voltage pulse is applied to start the arc, an auxiliary low voltage current is applied for a short time, and then the main weld current is applied via the resulting arc.

In order to overcome the electrical disadvantages associated with a high voltage arc start system which can lead to the possibility of the electrode arcing to the current return nozzle or associated parts of the assembly not to be welded, a touch retract torch may be used.

In touch retract systems a low voltage circuit is completed and the electrode immediately retracts drawing a high current arc between the electrode tip and the workpiece. When a preset gap is reached the retraction ceases and the weld sequence completes when the arc duration has expired, a predetermined amount of energy has been transferred or the electrode has moved so far away the arc fails

Disadvantages of known touch retract systems include the fact that it is difficult to locate the electrode on the weld site due to the fact that it is generally concealed by a contact tube/current return electrode. As the electrode wears the gap created when the electrode is retracted increases and hence changes the characteristics of the weld created. These disadvantages are presently overcome by the use of complex & expensive positional servo systems whereas this invention provides a simple low cost solution to these disadvantages.

### SUMMARY OF THE INVENTION

According to the invention there is provided a touch retract welding torch comprising: an electrode; a nozzle surrounding the electrode; a mechanical retraction mechanism comprising a gripper for gripping the electrode and arranged in operation to engage the gripper and retract the electrode away from a weld site by a predetermined distance; activating means arranged in operation to trigger said retraction mechanism.

Preferably, in a first configuration the electrode protrudes from the nozzle to allow the operator to view and easily locate the electrode. It is an advantage if the electrode can slide from the first configuration to a second configuration where the ends of the electrode and the nozzle are co-planar such that they may concurrently touch the weld site.

In a preferred embodiment the nozzle acts as a return electrode. The nozzle may also act as a means of applying force to press two or more parts of the work piece together and as a shield gas nozzle.

Preferably the mechanical retraction mechanism further comprises: a piston through which the electrode extends; and in which the gripper comprises: gripper arms pivotally attached to an upper end of the piston such that rotation of the gripper arms about a pivot point causes the gripper arms to engage and clamp said electrode.

It is an advantage if the piston is resiliently attached to a piston lock and in which said piston lock remains stationery as said gripper arms pivot and retract the piston together with the gripper arms thus increasing the frictional force between the gripper arms and the electrode.

In a preferred embodiment the mechanical retraction mechanism further comprises a swing arm connected to an end of each of said gripper arms and resiliently connected to said activation means and in which the activation means triggers the retraction mechanism by pivoting said swing arm from an unengaged position to an engaged position causing the gripper arms to pivot and engage said electrode; and in which further pivoting of the swing arm retracts the piston together with the gripper arms and hence the electrode.

Preferably the welding apparatus further comprises a return spring arranged to ensure the return of the swing arm to said unengaged position.

In a preferred embodiment a stop prevents the piston from retracting beyond said predetermined distance.

The activation mechanism may be a solenoid and may be one of a linear motion actuator or a pneumatic/ hydraulic cylinder actuator.

Preferably a single open loop linear motion is converted to means by which an electrode may be gripped and moved a preset distance.

### BRIEF DESCRIPTION OF THE DRAWINGS

The invention will now be described by way of example only, with reference to the accompanying drawings in which:

FIGS. 1a, 1b and 1c illustrate a touch retract torch according to the present invention in a sequence of configurations during operation of a weld;

FIG. 2 illustrates a retract mechanism for use in the present invention;

FIG. 3 illustrates two views of a gripper arm for use in the present invention;

FIG. 4 illustrates two views of a pull arm for use in the present invention;

FIG. 5 illustrates two views of a piston for use in the present invention;

FIG. 6 illustrates two views of a piston lock for use in the present invention;

FIG. 7 illustrates two views of a stop for use in the present invention;

FIG. 8 illustrates two views of a current return nozzle for use in the present invention;

FIG. 9 illustrates a swing arm for use in the present invention;

FIGS. 10a and 10b illustrate a cross section and a perspective view of the retract mechanism in a relaxed/open configuration prior to activation of the solenoid;

FIGS. 11a and 11b illustrate a cross section and a perspective view of the retract mechanism in a close/gripping configuration once the solenoid is activated;

FIGS. 12a and 12b illustrate cross sections perpendicular to those shown in FIGS. 10a and 11a of the retract mechanism; and

FIGS. 13a and 13b shown a piston and piston lock and piston spring only in the open/relaxed and closed/gripping configuration.

### DETAILED DESCRIPTION

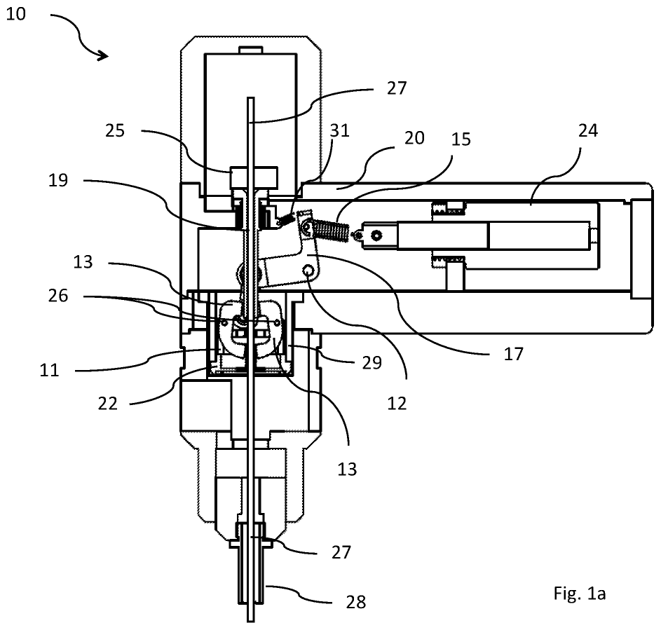

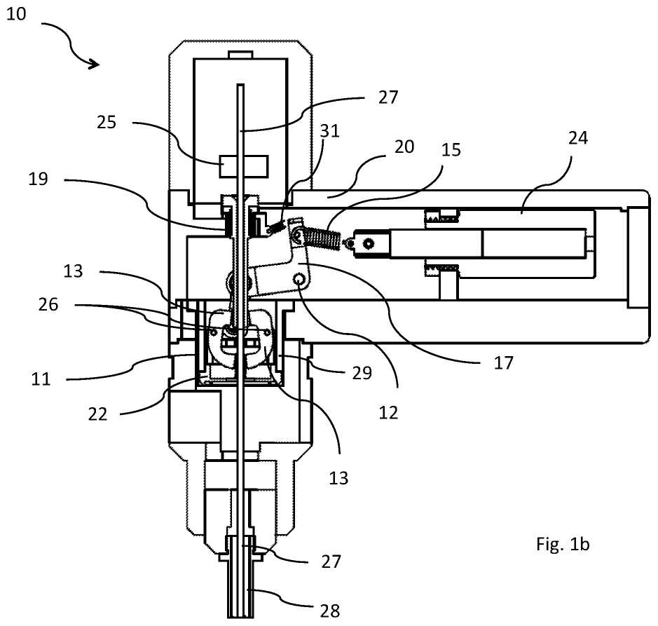

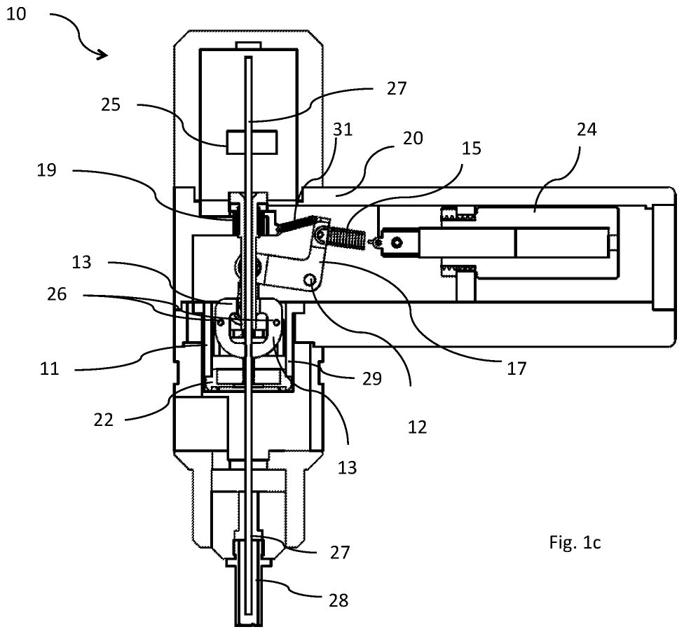

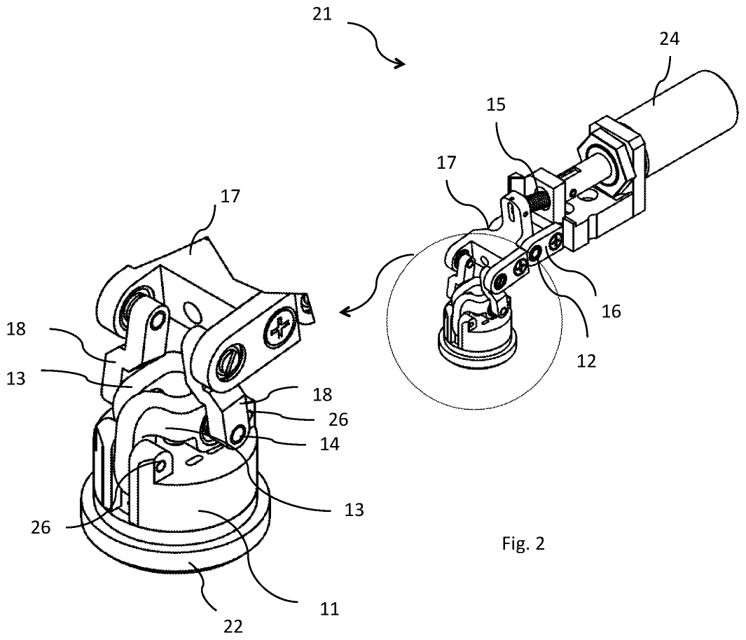

Referring to FIG. 1 the touch retract Tungsten Inert Gas (TIG) torch 10 comprises a housing 20 containing a solenoid 24 for tensioning and releasing a spring 15 to activate and deactivate a retract mechanism 21(Figure 2) in order to retract and release an electrode 27.

FIG. 2 shows the retract mechanism 21 comprising a swing arm 17, gripper arms 13 and a piston 11. The swing arm 17 pivots about base 16 by parallel pins forming a pivot point 12 located near to an elbow of the swing arm 17.

The spring 15 connects a first portion of the swing arm to the solenoid 24 such that when the solenoid is activated the spring is extended and the swing arm 17 rotates about the pivot point 12.

The swing arm 17 is connected via pull arms 18 and respective mounting pins 14 to a pair of gripper arms 13 which extend within a piston 11. The gripper arms pivot about points 26 of the piston 11.

The piston 11 is resiliently connected, via two springs 23 (not shown) to a piston lock 22 which remains stationary during the retract phase

When the swing arm 17 rotates about pivot point 12 this in turn causes the gripper arms 13 to rotate about their pivot points 26 and cause the tips of the gripper arms 13 to move toward one another in order to clamp the electrode 27.

Further rotational movement of the swing arm 17 causes the gripper arms 13, the piston 11, and the electrode 27 to move upwards as the gripper arms cannot close any further onto the electrode until a predetermined stop 19 prevents further upwards movement.

Returning to FIGS. 1 a-1c once the weld is complete, the solenoid 24 is deactivated. Spring 15 returns to its relaxed state and a return spring 31 serves to aid swing arms 17 to return to its lower position and open the gripper arms 13. Springs 23 (not shown) cooperate with the return spring 31 to return the piston 11 to its original position.

The housing 20 also supports a current return gas nozzle 28 for completing the circuit once the weld current is activated.

FIG. 1a illustrates the torch 10 in a first configuration, prior to a weld being carried out. The electrode 27 extends through the current return gas nozzle 28 so that it is visible whilst the torch is being located at the weld position.

FIG. 1b illustrates the torch 10 after the electrode has been located at the weld position and the torch lowered so that the electrode is pushed up within the nozzle 28 such that the electrode is flush with the nozzle and the work piece.

The current return gas nozzle 28 may then be used to exert pressure on the weld site in order to maintain mechanical contact between the pieces to be welded during the weld process.

FIG. 1c illustrates the torch after the retract mechanism has been activated during the weld process.

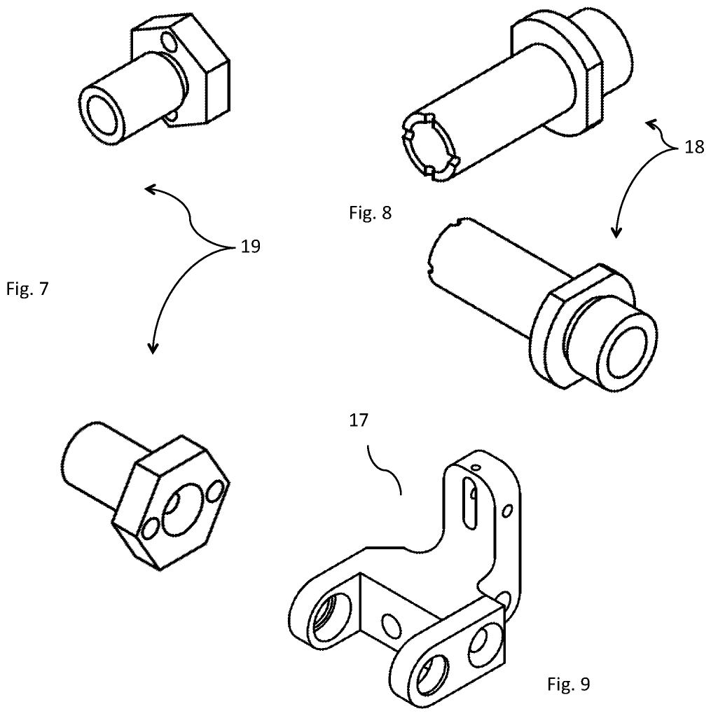

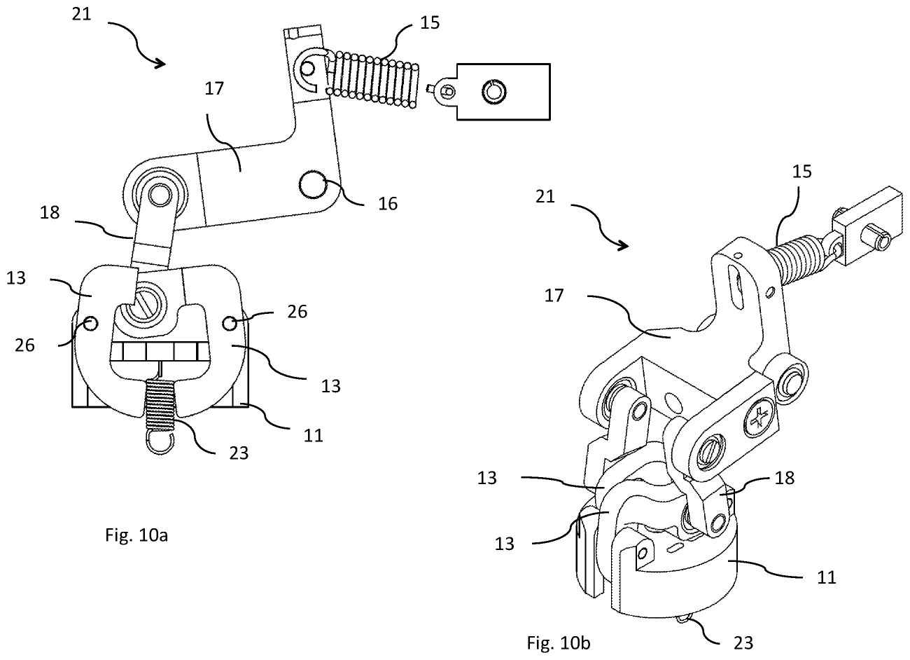

FIGS. 3 to 9 illustrate individual parts of the touch retract torch in further detail. The process of performing a touch retract weld using the torch of the present invention will now be described with reference to FIGS. 10 to 12 as well as FIGS. 1a-1c.

Before commencing a weld the electrode 27 may be configured to protrude from the current return gas nozzle 28 so that the torch 10 can be easily positioned to locate the electrode 27 at the desired weld position. A copper block 25 attached to the top of the electrode 27 abuts the top of stop 19 to set the maximum distance that the electrode 27 can protrude.

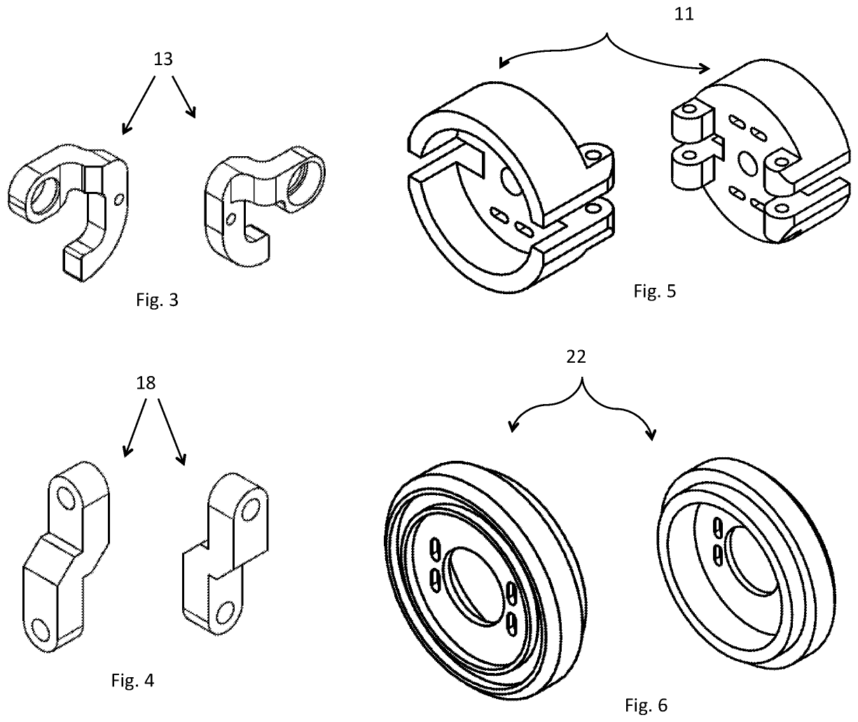

The retract mechanism 21 is shown in the initial relaxed/open configuration in FIG. 10a and 10b. The spring 15 is un-tensioned, swing arm 17 (shown in isolation in FIG. 9) is angled slightly downward and gripper arms 13 (shown in isolation in FIG. 3) are open. The piston 11 (shown in isolation in FIG. 5) is linked by a pair of piston springs 23 to the piston lock 22 (not shown here, shown in isolation in FIG. 6) such that they are pulled closed together.

As previously shown in FIG. 1b once the electrode is located on the weld site the torch 10 continues to be lowered, thus the electrode 27 is pushed upwards through the open gripper arms until the current return gas nozzle 28 surrounds the weld site and the electrode 27 is no longer visible.

When the torch 10, electrode 27 and nozzle 28 are in place the weld sensing current is now ready to be applied to the electrode. When this happens a short circuit current starts to flow which is readily detected and used as a trigger to drive the retract solenoid 24 in the torch. Activating the solenoid 24 immediately causes the retract mechanism 21 to engage and lift the gripper arms 13 and thus the electrode 27 is retracted to draw an electric arc therefore creating the weld. Gas flow can be channelled around the electrode. In the preferred embodiment, there are castellations in the gas nozzle/return electrode to allow the gas to exit.

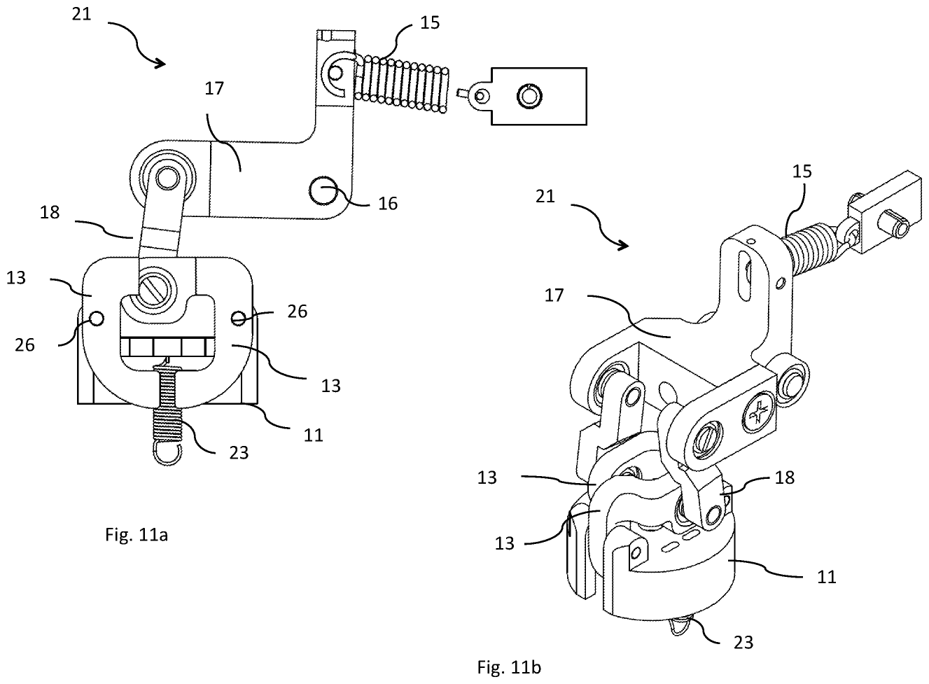

FIGS. 11a and 11b illustrate the retract mechanism 21 now in the retracted or closed configuration. The spring 15 is tensioned, swing arm 17 is pulled upwards and gripper arms 13 are closed. The piston 11 linked by a pair of springs 23 to the piston lock 22 (not shown, and which cannot move) which can move apart.

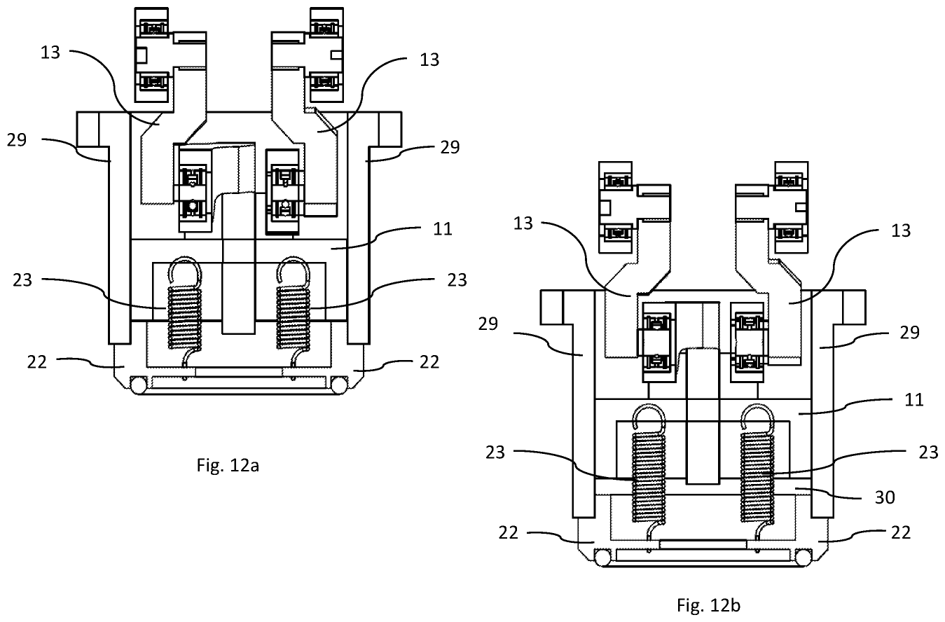

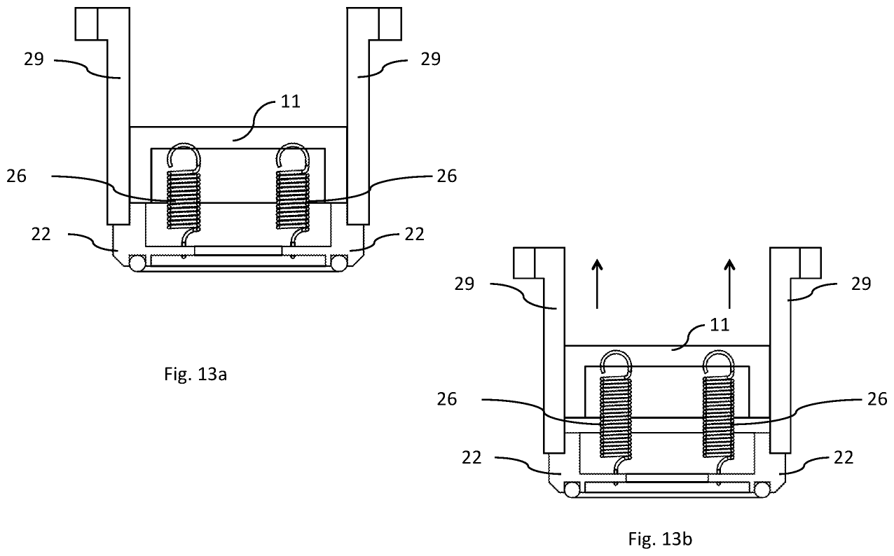

In order to understand the way in which the piston 11, springs 23 and piston lock 22 cooperate during the retraction operation, FIGS. 12a and 12b show a cross section perpendicular to those of FIGS. 10a and 11a of the retract mechanism in the open/relaxed and closed/gripping configuration. The piston 11 and piston lock are housed in a piston housing 29. When the gripper arms 13 are raised by the swing arm 17 (not shown) they rotate about the gripper arm pivot points 26 (not shown) and also urge the piston 11 upwards. The piston 11 is resiliently connected to the piston lock 22 by a pair of springs 23. However, the piston lock 22 is prevented from moving upwards by piston housing 29. Therefore as well as the gripper arms 13 pivoting and lifting slightly proud of the piston housing 29, the piston 11 is pulled away from the piston lock 22 to leave a small gap 30 (FIG. 12b) until the piston 11 is prevented from further upwards movement by stop 19 (FIGS. 1 a-1c). FIGS. 13a and 13b illustrate the movement between the piston 11 and the piston lock 22 more clearly.

Due to the presence of the stop 19, the electrode is retracted by exactly the same distance for every weld. In the preferred embodiment, this distance is approximately 1 mm. In general, electrodes experience wear during use and become shorter. However, due to the fact the gripper arms 13 are only engaged once the electrode is touching the weld site, then the electrode 27 is retracted a fixed distance each time due to the stop 19, such wear does not affect the distance the electrode is retracted during the weld process, thus resulting in consistent welds throughout the life of the electrode.

Current flow is maintained while pressure is applied downwards until the weld pulse ends. Once the weld is completed, the solenoid 24 is deactivated and the piston 11 returns to its original position as described above.

It will be understood that positional terms in the description above relate to operation of the torch in a substantially upright orientation in which the torch is lowered onto the desired weld site. It will be appreciated that the torch can be operated in any desired orientation such as in a horizontal plane or may even be raised toward a weld site and any positional terms should be understood in this context.

1. A touch retract arc welding torch comprising:
an electrode;
a nozzle, the nozzle surrounding the electrode and the nozzle having an end for making contact with a weld site of a work piece;
a mechanical retraction mechanism configured to withdraw an end of the electrode away from said weld site by a predetermined distance to draw an electric arc between said withdrawn electrode end and said weld site in order to create the weld, the mechanical retraction mechanism comprising gripper arms configured to engage and clamp the electrode when the end of the electrode is withdrawn away from said weld site and to disengage and release the electrode, in which, when the gripper arms are not engaged the electrode is mobile and is slidable between a first configuration in which the end of the electrode protrudes from the end of the nozzle and a second configuration in which the end of the electrode and the end of the nozzle are co-planar such that, in use, the end of the electrode and the end of the nozzle concurrently touch said weld site; and
an activating means arranged in operation to trigger the retraction mechanism;
wherein the retraction mechanism, when triggered by the activating means, is configured, in use, first to engage and clamp said mobile electrode in the second configuration and then to retract said clamped electrode away from the weld site whereby the end of the electrode is withdrawn by said predetermined distance to draw said electric arc.

2. The touch retract arc welding torch of claim 1, in which the end of the electrode when in the first configuration is configured to protrude from the end of the nozzle so that, in use, the end of the electrode is visible to a user of the torch during positioning of the end of the electrode at a desired position of said weld site.

3. The touch retract arc welding torch of claim 2, in which a copper block attached to a top of the electrode, said block abutting the top of a stop in order to set a maximum distance of said protrusion.

4. The touch retract arc welding torch of claim 1, in which the mechanical retraction mechanism further comprises a piston through which the electrode extends, the gripper arms being pivotally attached to an end of the piston such that rotation of the gripper arms about a pivot point causes the gripper arms to engage and clamp the electrode.

5. The touch retract arc welding torch of claim 4 in which the piston is resiliently attached to a piston lock and in which the piston lock remains stationery as the gripper arms pivot and retract the piston together with the gripper arms thus increasing a frictional force between the gripper arms and the electrode.

6. The touch retract arc welding torch of claim 4, in which the mechanical retraction mechanism further comprises a swing arm connected to an end of each of the gripper arms and resiliently connected to the activating means and in which the activating means triggers the retraction mechanism by pivoting the swing arm from an unengaged position to an engaged position causing the gripper arms to pivot and engage and clamp the electrode, and in which further pivoting of the swing arm retracts the piston together with the gripper arms and hence the electrode.

7. The touch retract arc welding torch to of claim 6 further comprising a return spring arranged to return the swing arm to the unengaged position.

8. The touch retract arc welding torch of claim 4, in which a stop prevents the piston from retracting beyond said predetermined distance.

9. The touch retract arc welding torch of claim 1, in which the activating means is a solenoid.

10. The touch retract arc welding torch claim of claim 1, in which the activating means is a linear motion actuator.

11. The touch retract arc welding torch of claim 1, in which the activating means is a pneumatic or hydraulic cylinder actuator.

12. The touch retract arc welding torch of claim 1, in which the electrode is a tungsten electrode and the nozzle is a current return gas nozzle for completing a circuit once a weld current is activated.

13. A method of using a touch retract arc welding torch to weld a work piece, the torch comprising:
an electrode;
a nozzle, the nozzle surrounding the electrode and the nozzle having an end;
a mechanical retraction mechanism configured to withdraw an end of the electrode away from a weld site, the mechanical retraction mechanism comprising gripper arms configured to engage and clamp the electrode and to disengage and release the electrode; and
an activating means arranged in operation to trigger the retraction mechanism;
the method comprising:
disengaging and releasing the gripper arms from the electrode so that the electrode is mobile and is slidable between a first configuration in which the end of the electrode protrudes from the end of the nozzle and a second configuration in which the end of the electrode and the end of the nozzle are co-planar;
bringing the end of the nozzle into contact with the weld site of the work piece with the end of the electrode at a desired position of the weld site, said mobile electrode sliding until the end of the electrode and the end of the nozzle are co-planar;
wherein the retraction mechanism, when triggered by the activating means, is configured first to engage and clamp said mobile electrode in the second configuration and then to retract said clamped electrode away from the weld site whereby the end of the electrode is withdrawn by said predetermined distance to draw said electric arc between said withdrawn electrode end and the weld site in order to create the weld.

14. The method according to claim 13, in which the end of the electrode when in the first configuration protrudes from the end of the nozzle so that the end of the electrode is visible to a user of the torch during positioning of the end of the electrode, the method comprising the user viewing said protruding end of the electrode as the end of the electrode is positioned at said desired position of the weld site.

15. The touch retract arc welding torch of claim 5, in which the mechanical retraction mechanism further comprises a swing arm connected to an end of each of the gripper arms and resiliently connected to the activating means and in which the activating means triggers the retraction mechanism by pivoting the swing arm from an unengaged position to an engaged position causing the gripper arms to pivot and engage and clamp the electrode, and in which further pivoting of the swing arm retracts the piston together with the gripper arms and hence the electrode.

16. The touch retract arc welding torch of claim 7, further comprising a return spring arranged to return the swing arm to the unengaged position.
